(19) United States
(12) Patent Application Publication
(10) Pub. No.: US 2023/0095309 A1
(43) Pub. Date: Mar. 30, 2023

(54) TEMPERATURE SENSOR

(71) Applicant: FUTABA CORPORATION, Mobara-shi (JP)

(72) Inventor: Takashi INOUE, Mobara-shi (JP)

(73) Assignee: Futaba Corporation, Mobara-shi (JP)

(21) Appl. No.: 17/939,382

(22) Filed: Sep. 7, 2022

(30) Foreign Application Priority Data
Sep. 30, 2021 (JP) 2021-160929

(51) Int. Cl. G01K 11/32; G01K 1/08; B29C 45/78

(52) U.S. Cl. CPC G01K 11/32; B29C 45/78; G01K 1/08; B29C 2945/7604; B29C 2945/7618; B29C 2945/76461

(57) ABSTRACT

A temperature sensor used in a molding machine is provided. The temperature sensor comprises a cylindrical fiber probe through which an optical fiber is inserted; an outer housing having a shaft, into which the fiber probe is inserted to be displaceable in an axial direction; a protective window disposed on a tip end side of the fiber probe and configured to protect a tip end of the fiber probe; and an elastic member that presses the fiber probe toward the protective window.

### TECHNICAL FIELD

The present disclosure relates to a technical field of a temperature sensor used in a molding machine and using an optical fiber.

### BACKGROUND

A molding machine for molding a resin molded product is provided with a sensor for measuring a temperature or pressure of resin in a cavity. As for such a sensor, there is known, e.g., a temperature sensor that allows a fiber probe, into which an optical fiber for measuring a temperature of resin filled in a cavity, is inserted to communicate with the cavity and transmits infrared rays emitted from the resin to a detector through the optical fiber (see, e.g., Japanese Laid-open Patent Publication No. 2008-232753).

### SUMMARY

In the above-described sensor, the heat resistance is improved by providing a protective window made of glass on a tip end side of the fiber probe so that the measurement can be performed in a higher temperature environment. The temperature sensor provided with the protective window has an outer housing for supporting the protective window and also protecting the fiber probe from heat.

However, in the temperature sensor provided with the protective window, the outer housing becomes hotter than the fiber probe due to the heat generated from the molding machine, and the outer housing expands more than the fiber probe does. Thus, a gap is generated between the fiber probe and the protective window, and optical interference occurs in the gap, which may deteriorate the measurement accuracy.

Therefore, the present disclosure has a purpose of ensuring high measurement accuracy while improving heat resistance.

To this end, first of all, a temperature sensor used in a molding machine is provided, comprising a cylindrical fiber probe through which an optical fiber is inserted; an outer housing having a shaft, into which the fiber probe is inserted to be displaceable in an axial direction; a protective window disposed on a tip end side of the fiber probe and configured to protect a tip end of the fiber probe; and an elastic member that presses the fiber probe toward the protective window.

Accordingly, the tip end of the fiber probe is pressed against the protective window by the pressing force of the elastic member regardless of the degree of expansion or contraction of the fiber probe and the outer housing during heating or cooling.

Second, it is desirable for the above temperature sensor to include an adjustment screw configured to adjust a pressing force of the elastic member with respect to the fiber probe.

Accordingly, the pressing force of the elastic member with respect to the fiber probe can be adjusted by the adjustment screw.

Third, in the above temperature sensor, it is desirable that the outer housing has a lid configured to protect the fiber probe, and the adjustment screw is screwed into the lid.

Accordingly, the lid has the function of supporting the adjustment screw and the function of covering the fiber probe or the like.

Fourth, in the above temperature sensor, it is desirable that a spring is used as the elastic member.

Accordingly, the elastic member has high heat resistance, and it is unnecessary to use a dedicated elastic member depending on measurement environments.

Fifth, in the above temperature sensor, it is desirable that a base end surface of the fiber probe is formed as a pressed surface; a flat plate-shaped rubber is used as the elastic member; and the elastic member is in surface contact with the pressed surface.

Accordingly, the pressing force of the elastic member can uniformly act on the pressed surface.

### BRIEF DESCRIPTION OF THE DRAWINGS

The objects and features of the present disclosure will become apparent from the following description of embodiments, given in conjunction with the accompanying drawings, in which:

FIG. 1 shows an embodiment of the present disclosure together with FIGS. 2 to 5, and is a cross-sectional view of a temperature sensor according to an embodiment of the present disclosure;

FIG. 2 illustrates displacement of a fiber probe in a state where a temperature sensor is heated;

FIG. 3 illustrates displacement of the fiber probe in a state where the temperature sensor is cooled;

FIG. 4 is a cross-sectional view showing an example in which rubber is used as an elastic member; and

FIG. 5 is a cross-sectional view showing an example in which the elastic member is supported by a lid and the fiber probe.

### DETAILED DESCRIPTION

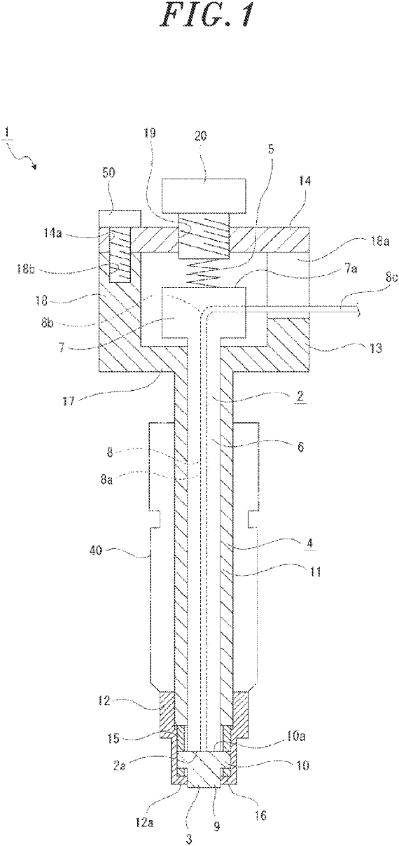

Hereinafter, an embodiment of a temperature sensor of the present disclosure will be described with reference to the accompanying drawings (see FIGS. 1 to 5).

The temperature sensor has a tubular fiber probe. In the following description, the axial direction of the fiber probe is defined as a vertical direction and the tip end side of the fiber probe is defined as a lower side to indicate vertical and horizontal directions. However, the vertical direction and the horizontal direction in the following description are defined for convenience of explanation, and the directions in the embodiment of the present disclosure are not limited thereto.

### Configuration of Temperature Sensor

First, the configuration of the temperature sensor will be described (see FIG. 1).

The temperature sensor 1 is installed at an injection molding machine (not shown), and is used for measuring a temperature of resin in an injection unit. The temperature sensor 1 is not necessarily installed at the injection molding machine, and may be installed at an extrusion molding machine, a blow molding machine, or the like.

The temperature sensor 1 has a fiber probe 2, a protective window 3, an outer housing 4, and an elastic member 5.

The fiber probe 2 has a tubular portion 6 whose axial direction coincides with the vertical direction, and a flange portion 7 extending from an upper end portion of the tubular portion 6. The outer diameter of the flange portion 7 is greater than the outer diameter of the tubular portion 6. The upper surface of the flange portion 7 is formed as a pressed surface 7a. The fiber probe 2 is made of, e.g., a metal material.

An optical fiber 8 is inserted and held in the fiber probe 2. One end 8a of the optical fiber 8 is inserted into the tubular portion 6, and a bent portion 8b extending from said one end 8a is bent in the flange portion 7 at a substantially right angle, for example. In the optical fiber 8, a portion between the bent portion 8b and the other end serves as an intermediate portion 8c, and the intermediate portion 8c extends from an outer peripheral surface of the flange portion 7 to the outside of the fiber probe 2. A detector (not shown) or the like is connected to the other end of the optical fiber 8.

The protective window 3 includes a small diameter portion 9 and a large diameter portion 10, each being formed in a cylindrical shape. The large diameter portion 10 extends from the upper end side of the small diameter portion 9. The upper surface of the large diameter portion 10 serves as a contact surface 10a. The protective window 3 is supported by a window support (to be described later) of the outer housing 4 in a state where the contact surface 10a is in contact with a tip end surface 2a of the fiber probe 2. The protective window 3 is made of, e.g., sapphire glass.

The outer housing 4 has a shaft 11, a window support 12, an arrangement portion 13, and a lid 14. The outer housing 4 is made of, e.g., a metal material. The fiber probe 2 is disposed in the outer housing 4.

The shaft 11 is formed in a cylindrical shape whose axial direction coincides with the vertical direction, and the tubular portion 6 of the fiber probe 2 is inserted thereinto. An installation nut 40 for installing the temperature sensor 1 at the injection molding machine is installed outside the shaft 11.

The window support 12 has a cylindrical shape whose axial direction coincides with the vertical direction, and the upper end portion thereof surrounds the lower end portion of the shaft 11. A flange-shaped receiving portion 12a protruding inward is disposed at the lower end portion of the window support 12.

The protective window 3, except the tip end portion thereof, a spacer 15, and an O-ring 16 are disposed in the window support 12. The spacer 15 is formed in a cylindrical shape, and the upper and lower end surfaces thereof are in contact with the bottom surface of the shaft 11 and the outer peripheral portion of the contact surface 10a in the protective window 3, respectively. The O-ring 16 is formed in an annular shape and is in close contact with the bottom surface of the large diameter portion 10 and the upper surface of the receiving portion 12a.

The arrangement portion 13 has a flange portion 17 protruding outward from the upper end portion of the shaft 11 and an annular portion 18 protruding upward from the outer peripheral portion of the flange portion 17. The annular portion 18 has a notch 18a that is opened upward and penetrated in a radial direction. Installation holes 18b opened upward are formed at the upper end of the annular portion 18 while being spaced apart from one another in the circumferential direction. The flange portion 7 of the fiber probe 2 is disposed in the arrangement portion 13, and the intermediate portion 8c of the optical fiber 8 is inserted into the notch 18a.

The lid 14 is formed in an annular shape, and has a screw hole 19 at the central portion thereof. The adjustment screw 20 is screwed into the screw hole 19. Screw insertion holes 14a are formed through the outer peripheral portion of the lid 14 to correspond to the installation holes 18b of the annular portion 18. The lid 14 is installed on the upper surface of the arrangement portion 13 by screwing installation screws 50 inserted into the screw insertion holes 14a into the installation holes 18b. The elastic member 5 is disposed between the bottom surface of the adjustment screw 20 and the pressed surface 7a of the fiber probe 2 in a state where the lid 14 is installed at the arrangement portion 13.

The elastic member 5 may be, e.g., a compression coil spring. The fiber probe 2 is pressed downward (toward the tip end side) by the elastic force of the elastic member 5, and the tip end surface 2a is pressed against the contact surface 10a of the protective window 3. A disc spring, a leaf spring, or the like may be used as the elastic member 5.

In the temperature sensor 1, the pressing force of the elastic member 5 with respect to the fiber probe 2 can be adjusted by changing the screwing position of the adjustment screw 20 with respect to the screw hole 19 by rotating the adjustment screw 20.

### Function of Elastic Member

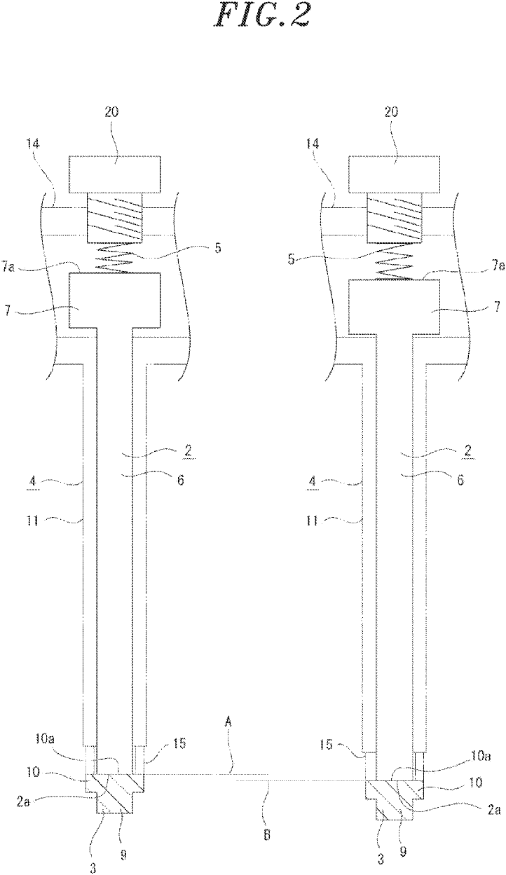

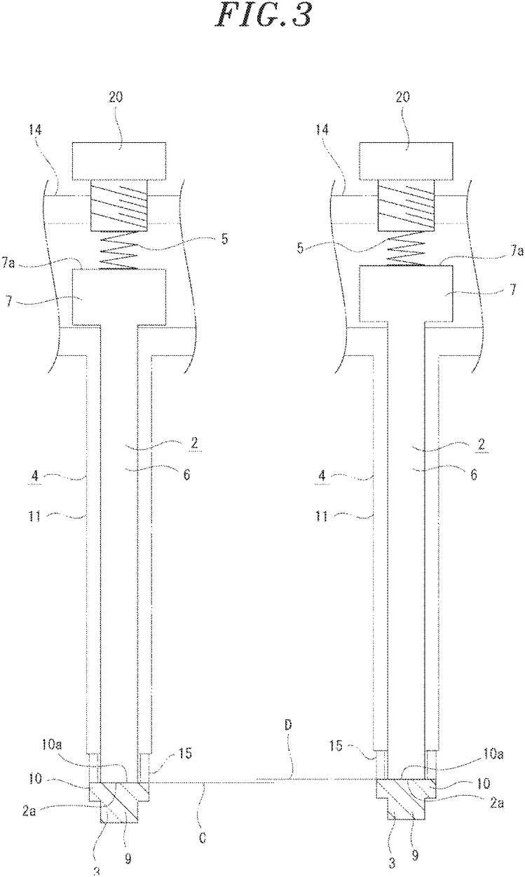

Next, the function of the elastic member 5 in the temperature sensor 1 will be described (see FIGS. 2 and 3).

In FIGS. 2 and 3, in order to clearly illustrate the displacement of the fiber probe 2 and the protective window 3, certain components are omitted and the displacement amount of the fiber probe 2 and the protective window 3 is illustrated in an exaggerated manner.

The left side of FIG. 2 shows the temperature sensor 1 that is not heated. A line A indicates the height of the tip end surface 2a of the fiber probe 2 and the contact surface 10a of the protective window 3 in the vertical direction.

The temperature sensor 1 is heated by the heat generated in the injection molding machine at the time of measurement, for example. In the temperature sensor 1, in the initial stage of the measurement, the heating amount of the outer housing 4 located at the outer side is greater than the heating amount of the fiber probe 2 located at the inner side, so that the degree of expansion of the outer housing 4 is greater than the degree of expansion of the fiber probe 2. When the outer housing 4 expands, the protective window 3 supported by the window support 12 is displaced in a direction (downward direction) away from the fiber probe 2 due to the expansion of the window support 12, and the contact surface 10a is displaced to a position lower than the line A (see line B in the right side of FIG. 2).

Although the protective window 3 is displaced downward, in the temperature sensor 1, the fiber probe 2 is pressed toward the protective window 3 by the pressing force of the elastic member 5 and, thus, the fiber probe 2 is displaced downward together with the protective window 3, and the state in which the tip end surface 2a is pressed against the contact surface 10a of the protective window 3 is maintained.

When the temperature sensor 1 is further heated in the above-described state, the temperature of the fiber probe 2 disposed in the outer housing 4 increases gradually, and the degree of expansion of the fiber probe 2 increases. At this time, the protective window 3 may be moved up and down depending on the degree of relative expansion of the fiber probe 2 and the outer housing 4. However, the pressing force of the fiber probe 2 with respect to the protective window 3 due to the expansion is absorbed by the elastic member 5, and the state in which the tip end surface 2a is pressed against the contact surface 10a is maintained while preventing the fiber probe 2 from being excessively pressed against the protective window 3.

On the other hand, when the heating of the temperature sensor 1 is stopped from the state in which the individual components of the temperature sensor 1 are expanded by the heating (see the left side of FIG. 3), the fiber probe 2 and the outer housing part 4 start to contract. At this time, first, the degree of contraction of the outer housing 4 becomes greater than the degree of contraction of the fiber probe 2, and the protective window 3 is displaced in a direction (upward direction) toward the fiber probe 2 (see the right side of FIG. 3).

At this time, the fiber probe 2 is pressed from below by the protective window 3, and is displaced upward with respect to the shaft 11 against the pressing force of the elastic member 5. The tip end surface 2a of the fiber probe 2 and the contact surface 10a of the protective window 3 are displaced upward from the line C to the line D. Therefore, the force is not excessively applied to the protective window 3 when the outer housing 4 contracts, so that damage to the protective window 3 can be prevented.

When the temperature sensor 1 is further cooled from the above-described state, the degree of contraction of the fiber probe 2 increases. At this time, the protective window 3 may be moved up and down depending on the degree of relative contraction of the fiber probe 2 and the outer housing 4. However, the pressing force of the protective window 3 with respect to the fiber probe 2 due to the contraction is absorbed by the elastic member 5, and the state in which the tip end surface 2a is pressed against the contact surface 10a is maintained while preventing the protective window 3 from being excessively pressed against the fiber probe 2.

As described above, in the temperature sensor 1, the state in which the tip end portion of the fiber probe 2 is pressed against the protective window 3 by the pressing force of the elastic member 5 is maintained regardless of the degree of expansion or contraction of the fiber probe 2 and the outer housing 4 during heating or cooling, and the pressing force generated between the fiber probe 2 and the protective window 3 is absorbed by the elastic member 5.

Therefore, no gap is generated between the fiber probe 2 and the protective window 3, and the high measurement accuracy of the temperature sensor 1 can be ensured. Further, an excessive force is not applied to the protective window 3, so that damage to the protective window 3 can be prevented.

The temperature sensor 1 further includes the adjustment screw 20 for adjusting the pressing force of the elastic member 5 with respect to the fiber probe 2.

Accordingly, the pressing force of the elastic member 5 with respect to the fiber probe 2 can be adjusted by the adjustment screw 20. Hence, it is possible to randomly select the pressing force of the elastic member 5 with respect to the fiber probe 2 depending on types of the fiber probe 2 or the injection molding machine and the configuration of the temperature sensor 1 so that the optimum measurement state of the temperature sensor 1 can be obtained.

Further, in the temperature sensor 1, the adjustment screw 20 is screwed into the lid 14 of the outer housing 4.

Accordingly, the lid 14 has the function of supporting the adjustment screw 20 and the function of covering the fiber probe 2 or the like and, thus, a dedicated member for supporting the adjustment screw 20 is not required. Hence, the number of components can be reduced, and the pressing force of the elastic member 5 can be randomly selected.

Further, in the temperature sensor 1, a spring is used as the elastic member 5.

Since the elastic member 5 has high heat resistance, it is unnecessary to use a dedicated elastic member 5 depending on measurement environments, and the temperature sensor 1 can be variously utilized.

### Other Applications

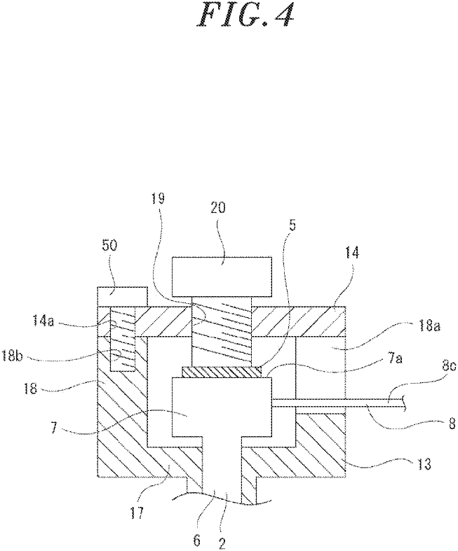

Although the example in which the spring is used as the elastic member 5 has been described, rubber may be used as the elastic member 5 (see FIG. 4). The elastic member 5 is formed in a flat plate shape, for example, and the upper surface and the bottom surface thereof are in surface contact with the adjustment screw 20 and the pressed surface 7a of the fiber probe 2, respectively.

Hence, the pressing force of the elastic member 5 uniformly acts on the pressed surface 7a, so that the displacement of the fiber probe 2 in a direction other than the axial direction is suppressed, and the fiber probe 2 can be reliably pressed toward the protective window 3.

The rubber used for the elastic member 5 is not limited to natural rubber or synthetic rubber, and may be silicon rubber. In the case of using silicon rubber having higher heat resistance compared to natural rubber or the like for the elastic member 5, the temperature sensor 1 can be variously utilized. Further, a foam or the like may be used, instead of the above-described spring or rubber, for the elastic member 5.

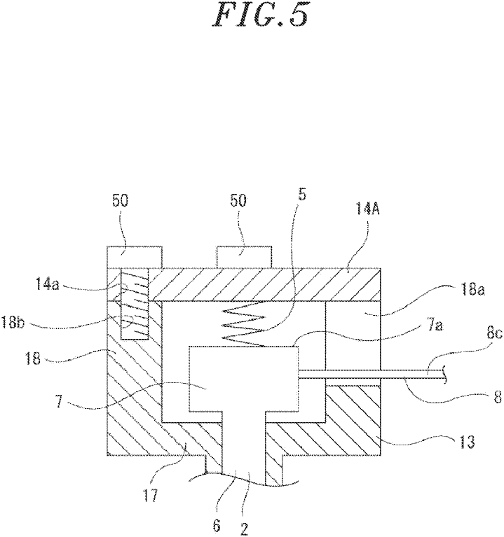

Although the example in which the adjustment screw 20 is screwed into the annular lid 14 has been described, a disc-shaped lid 14A may be provided, instead of the lid 14, and the elastic member 5 may be disposed between the bottom surface of the lid 14A and the pressed surface 7a (see FIG. 5). Accordingly, the number of components can be reduced.

1. A temperature sensor used in a molding machine, comprising:
a cylindrical fiber probe through which an optical fiber is inserted;
an outer housing having a shaft, into which the fiber probe is inserted to be displaceable in an axial direction;
a protective window disposed on a tip end side of the fiber probe and configured to protect a tip end of the fiber probe; and
an elastic member that presses the fiber probe toward the protective window.

2. The temperature sensor of claim 1, further comprising:
an adjustment screw configured to adjust a pressing force of the elastic member with respect to the fiber probe.

3. The temperature sensor of claim 2, wherein:
the outer housing has a lid configured to protect the fiber probe, and
the adjustment screw is screwed into the lid.

4. The temperature sensor of claim 1, wherein a spring is used as the elastic member.

5. The temperature sensor of claim 2, wherein a spring is used as the elastic member.

6. The temperature sensor of claim 3, wherein a spring is used as the elastic member.

7. The temperature sensor of claim 1, wherein:
a base end surface of the fiber probe is formed as a pressed surface,
a flat plate-shaped rubber is used as the elastic member, and
the elastic member is in surface contact with the pressed surface.

8. The temperature sensor of claim 2, wherein:
a base end surface of the fiber probe is formed as a pressed surface,
a flat plate-shaped rubber is used as the elastic member, and
the elastic member is in surface contact with the pressed surface.

9. The temperature sensor of claim 3, wherein:
a base end surface of the fiber probe is formed as a pressed surface,
a flat plate-shaped rubber is used as the elastic member, and
the elastic member is in surface contact with the pressed surface.
